(19) United States
(12) Patent Application Publication
(10) Pub. No.: US 2026/0177530 A1
(43) Pub. Date: Jun. 25, 2026

(54) STRUCTURAL INSPECTION USING MACHINE LEARNING MODELS

(71) Applicant: Chevron U.S.A. Inc., San Ramon, CA (US)

(72) Inventors: Robert Kwan Meng Seah, Cypress, TX (US); David Hugh Fraser, Tomball, TX (US); Larry A. Bowden, JR., Houston, TX (US)

(21) Appl. No.: 19/000,400

(22) Filed: Dec. 23, 2024

(51) Int. Cl. G01N 29/44; G01N 29/06; G01N 29/12; G01N 29/24; G01N 29/46; G06N 20/00

(52) U.S. Cl. CPC G01N 29/4445; G01N 29/0654; G01N 29/12; G01N 29/2418; G01N 29/4472; G01N 29/46; G06N 20/00; G01N 2291/0289

(57) ABSTRACT

Different machine learning models are trained to detect different types of defects in structures. A machine learning model is trained using pairs of waveforms/wavefields measured from a structure over durations of time and labels for the defect in the structure, which enables the machine learning model to learn and interpret features from acoustic wave amplitude propagation over time. The trained machine learning models serve as proxy of the physics models to detect defects in the structures. The trained machine learning models improves the efficiency and effectiveness of the inspection process by analyzing the waveform/wavefield measurements more accurately and quickly.

### FIELD

The present disclosure relates generally to the field of inspecting structures for defects.

### BACKGROUND

Waveform/wavefield measurements from structures may be processed and analyzed using physics models to detect defects in the structures. Operator expertise may be crucial for proper processing of the waveform/wavefield measurements and accurate interpretation of the outputs from the physics models. Such inspections of structures may rely on subjective processing and interpretation by the operator.

### SUMMARY

This disclosure relates to structural inspection. Different sets of acoustic excitation measurement from one or more structures for different defects may be obtained. The different sets of acoustic excitation measurement from the structure(s) for different defects may include a first set of acoustic excitation measurement from the structure(s) for a first type of defect, a second set of acoustic excitation measurement from the structure(s) for a second type of defect different from the first type of defect, and/or other set(s) of acoustic excitation measurement from the structure(s) for other type(s) of defect. The different sets of acoustic excitation measurement from the structure(s) for different defects may include waveforms/wavefields measured from the structure(s) over durations of time. Different sets of defect characterization for the structure(s) may be obtained. The different sets of defect characterization for the structure(s) may correspond to the different sets of acoustic excitation measurement from the structure(s). The different sets of defect characterization for the structure(s) may include a first set of defect characterization for the structure(s) corresponding to the first set of acoustic excitation measurement from the structure(s) for the first type of defect, a second set of defect characterization for the structure(s) corresponding to the second set of acoustic excitation measurement from the structure(s) for the second type of defect, and/or other set(s) of defect characterization for the structure(s) corresponding to other set(s) of acoustic excitation measurement from the structure(s) for other type(s) of defect.

Different machine learning models for structural inspection may be trained. The different machine learning models may include a first machine learning model, a second machine learning model, and/or other machine learning models. The first machine learning model may be trained based on the first set of acoustic excitation measurement from the structure(s) for the first type of defect, the first set of defect characterization for the structure(s), and/or other information. The second machine learning model may be trained based on the second set of acoustic excitation measurement from the structure(s) for the second type of defect, the second set of defect characterization for the structure(s), and/or other information. Training of the different machine learning models using the waveforms/wavefields measured from the structure(s) over the durations of time may enable the different machine learning models to learn and interpret features from acoustic wave amplitude propagation over time. The trained machine learning models for structural inspection may be stored in a non-transient storage medium.

A system for structural inspection may include one or more electronic storage, one or more processors and/or other components. The electronic storage may store information relating to structures, information relating to defects, information relating to acoustic excitation measurement from structures, information relating to defect characterization for structure, information relating to machine learning models, and/or other information.

The processor(s) may be configured by machine-readable instructions. Executing the machine-readable instructions may cause the processor(s) to facilitate structural inspection. The machine-readable instructions may include one or more computer program components. The computer program components may include one or more of a measurement component, a characterization component, a train component, a storage component, an excitation component, a defect component, and/or other computer program components.

The measurement component may be configured to obtain different sets of acoustic excitation measurement for different defects. The different sets of acoustic excitation measurement may be obtained from one or more structures, The different sets of acoustic excitation measurement for different defects may include a first set of acoustic excitation measurement from the structure(s) for a first type of defect, a second set of acoustic excitation measurement from the structure(s) for a second type of defect different from the first type of defect, and/or other set(s) of acoustic excitation measurement from the structure(s) for other types of defect. The different sets of acoustic excitation measurement may include waveforms/wavefields measured from the structure(s) over durations of time.

In some implementations, the waveforms/wavefields may be measured from the structure(s) over the durations of time using multiple cycles of laser scanning. The waveforms/wavefields measured from the structure(s) over the durations of time may include time-series data of wave amplitudes and scanned locations on the structure(s). In some implementations, the waveforms/wavefields measured at different moments in time may be captured as different images.

In some implementations, the waveforms/wavefields may be simulated using one or more physics models for the structure(s).

In some implementations, the different sets of acoustic excitation measurement for different defects may further include a third set of acoustic excitation measurement from the structure(s) for a third type of defect. The third type of defect may be different from the first type of defect and the second type of defect.

In some implementations, the first type of defect may include corrosion, the second type of defect may include coating failure, and the third type of defect may include crack.

The characterization component may be configured to obtain different sets of defect characterization for the structure(s). The different sets of defect characterization for the structure(s) may correspond to the different sets of acoustic excitation measurement from the structure(s). The different sets of defect characterization may include a first set of defect characterization for the structure(s) corresponding to the first set of acoustic excitation measurement from the structure(s) for the first type of defect, a second set of defect characterization for the structure(s) corresponding to the second set of acoustic excitation measurement from the structure(s) for the second type of defect, and/or other sets of defect characterization for the structure(s) corresponding to other sets of acoustic excitation measurement from the structure(s) for other types of defect.

In some implementations, the different sets of defect characterization may further include a third set of defect characterization for the structure(s) corresponding to the third set of acoustic excitation measurement from the structure(s) for the third type of defect.

In some implementations, the first set of defect characterization may include corrosion characterization, the second set of defect characterization may include coating failure characterization, and the third set of defect characterization may include crack characterization.

The train component may be configured to train different machine learning models for structural inspection. The different machine learning models may include a first machine learning model, a second machine learning model, and/or other machine learning models. The first machine learning model may be trained based on the first set of acoustic excitation measurement from the structure(s) for the first type of defect and the first set of defect characterization for the structure(s). The second machine learning model may be trained based on the second set of acoustic excitation measurement from the structure(s) for the second type of defect and the second set of defect characterization for the structure(s). Training of the different machine learning models using the waveforms/wavefields measured from the structure(s) over the durations of time may enable the different machine learning models to learn and interpret features from acoustic wave amplitude propagation over time.

In some implementations, the different machine learning models may further include a third machine learning model. The third machine learning model may be trained based on the third set of acoustic excitation measurement from the structure(s) for the third type of defect and the third set of defect characterization for the structure(s).

In some implementations, a machine learning model may be trained by pairing multiple images captured over a duration of time with a single defect characterization.

The storage component may be configured to store the trained machine learning models for structural inspection in a non-transient storage medium.

The excitation component may be configured to obtain acoustic excitation measurement from one or more structures. A structure may have one or more defects.

The defect component may be configured to determine one or more defect characteristics in one or more structures. Defect characteristic(s) in a structure may be determined by using the trained machine learning models. The first machine learning model may be used to determine whether the defect(s) of a structure is the first type of defect. The second machine learning model is used to determine whether the defect(s) of a structure is the second type of defect.

In some implementations, the trained machine learning models may be used to further determine characteristics of the different types of defect in one or more structures. The first machine learning model may be used to determine characteristics of the first type of defect in a structure. The second machine learning model may be used to determine characteristics of the second type of defect in a structure.

In some implementations, one or more maintenance activities may be performed for one or more structures. Maintenance activit(ies) for a structure may be performed based on the defect characteristic(s) in the structure and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for structural inspection.

FIG. 2A illustrates an example method for structural inspection.

FIG. 2B illustrates an example method for structural inspection.

FIG. 3 illustrates example training data for structural inspection.

FIG. 4 illustrates an example acoustic excitation measurement from a structure.

FIG. 5 illustrates an example process for structural inspection.

### DETAILED DESCRIPTION

The present disclosure relates to structural inspection. Different machine learning models are trained to detect different types of defects in structures. A machine learning model is trained using pairs of waveforms/wavefields measured from a structure over durations of time and labels for the defect in the structure, which enables the machine learning model to learn and interpret features from acoustic wave amplitude propagation over time. The trained machine learning models serve as proxy of the physics models to detect defects in the structures. The trained machine learning models improve the efficiency and effectiveness of the inspection process by analyzing the waveform/wavefield measurements more accurately and quickly.

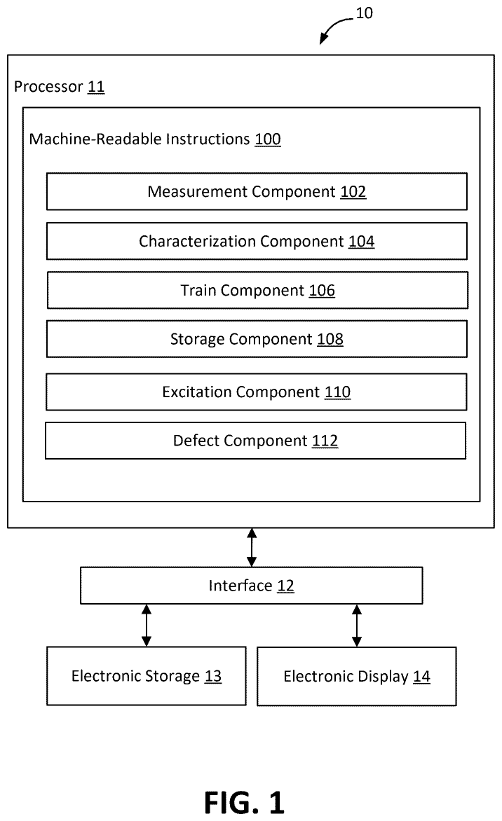

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. Different sets of acoustic excitation measurement from one or more structures for different defects may be obtained by the processor 11. The different sets of acoustic excitation measurement from the structure(s) for different defects may include a first set of acoustic excitation measurement from the structure(s) for a first type of defect, a second set of acoustic excitation measurement from the structure(s) for a second type of defect different from the first type of defect, and/or other set(s) of acoustic excitation measurement from the structure(s) for other type(s) of defect. The different sets of acoustic excitation measurement from the structure(s) for different defects may include waveforms/wavefields measured from the structure(s) over durations of time. Different sets of defect characterization for the structure(s) may be obtained by the processor 11. The different sets of defect characterization for the structure(s) may correspond to the different sets of acoustic excitation measurement from the structure(s). The different sets of defect characterization for the structure(s) may include a first set of defect characterization for the structure(s) corresponding to the first set of acoustic excitation measurement from the structure(s) for the first type of defect, a second set of defect characterization for the structure(s) corresponding to the second set of acoustic excitation measurement from the structure(s) for the second type of defect, and/or other set(s) of defect characterization for the structure(s) corresponding to other set(s) of acoustic excitation measurement from the structure(s) for other type(s) of defect.

Different machine learning models for structural inspection may be trained by the processor 11. The different machine learning models may include a first machine learning model, a second machine learning model, and/or other machine learning models. The first machine learning model may be trained based on the first set of acoustic excitation measurement from the structure(s) for the first type of defect, the first set of defect characterization for the structure(s), and/or other information. The second machine learning model may be trained based on the second set of acoustic excitation measurement from the structure(s) for the second type of defect, the second set of defect characterization for the structure(s), and/or other information. Training of the different machine learning models using the waveforms/wavefields measured from the structure(s) over the durations of time may enable the different machine learning models to learn and interpret features from acoustic wave amplitude propagation over time. The trained machine learning models for structural inspection may be stored by the processor 11 in a non-transient storage medium.

The electronic storage 13 may include one or more electronic storage media that electronically stores information. The electronic storage 13 may store software algorithms, information determined by the processor 11, information received remotely, and/or other information that enables the system 10 to function properly. For example, the electronic storage 13 may store information relating to structures, information relating to defects, information relating to acoustic excitation measurement from structures, information relating to defect characterization for structure, information relating to machine learning models, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present information relating to structures, information relating to defects, information relating to acoustic excitation measurement from structures, information relating to defect characterization for structure, information relating to machine learning models, and/or other information.

In some implementations, the system 10 may include one or more acoustic excitation devices, one or more acoustic measurement devices, and/or other devices. An acoustic excitation device may refer to a device that generates acoustic excitation in a structure. Acoustic excitation of a structure may refer to application of energy to the structure to generate acoustic responses in the structure. An acoustic response may refer to presence of and/or propagation of one or more mechanical waves/acoustic waves within the structure. That is, the structure may be acoustically excited to produce mechanical wave(s)/acoustic wave(s) within the structure. A mechanical wave/acoustic wave may include a wave within the audible range and/or a wave above the audible range.

An acoustic excitation device may be configured to generate acoustic excitation in the structure. An acoustic excitation device may apply energy to the structure to generate acoustic excitation in the structure mechanically (e.g., using one or more transducers, such as a piezoelectric transducer(s)), thermally (e.g., using one or more lasers), and/or by other ways. For example, energy (e.g., in form of sound, heat, ultrasound, vibration) may be applied to the structure through one or more transducers coupled to the structure, one or more pulse lasers, and/or other acoustic excitation devices. For instance, acoustic waves may be generated in a plate-like structure in response to ultrasonic excitation. The ultrasonic excitation/acoustic waves may be sensitive to different properties of the structures. For example, the ultrasonic excitation/acoustic waves may be sensitive to defects (e.g., damage) in the structure, which may change the characteristics of the ultrasonic excitation/acoustic waves where defects are located in the structure.

An acoustic measurement device may refer to a device that measures acoustic excitation in a structure. Measurement of acoustic excitation in a structure may include the acoustic response to the acoustic excitation in the structure. An acoustic measurement device may refer to a device that measures acoustic responses (e.g., displacement response, velocity response, acceleration response) in the structure. For example, a structure may be acoustically excited by an acoustic excitation device to produce mechanical wave(s)/acoustic wave(s) within the structure, and an acoustic measurement device may measure one or more characteristics of the mechanical wave(s)/acoustic wave(s) within the structure, and/or one or more characteristics of the structure that reflects (e.g., indicates, is impacted by) the mechanical wave(s)/acoustic wave(s) within the structure.

An acoustic measurement device may be configured to measure acoustic excitation in the structure. An acoustic measurement device may measure the acoustic excitation in the structure mechanically (e.g., using one or more transducers), optically (e.g., using a scanning laser), and/or by other ways. For example, acoustic excitation in the structure may be measured through one or more transducers coupled to the structure, scanning laser Doppler vibrometer, and/or other acoustic measurement devices. For example, an acoustic measurement device may measure acoustic responses (e.g., full-field surface velocity response) in the structure. An acoustic response may include a vibrational/wave response (e.g., full-wavefield response) in the audible range and/or above the audible range (ultrasonic response).

An acoustic measurement device may include a vibrometer. The vibrometer may include one or more vibrographs and/or other devices that measure the amplitude, velocity, and/or frequency of vibrations in a structure. In some implementations, the vibrometer may measure acoustic responses using one or more beams. For example, the vibrometer may include one or more laser Doppler vibrometers that uses a laser beam to measure acoustic responses in different portions of the structures. The acoustic responses may include the vibration/wave amplitude, velocity, and/or frequency within the structure. A scan path may refer to a path traced and/or followed by the beam(s) of the vibrometer along the structure to make the measurements. In some implementations, the vibrometer may use a raster scan to make the measurements (e.g., 2D or 3D measurements).

A structure may refer to the arrangement and/or organization of one or more things. Thing(s) may be arranged and/or organized into a structure to perform one or more functions. A structure may be composed of a particular type of matter or a combination of different types of matter. For example, a structure may include a metallic, rigid structure and/or other structure. For instance, a structure may be made of steel, alloys, composites, laminations, and other acoustically conductive materials. A structure may have a symmetrical shape or an asymmetrical shape. A structure may include one or more simple geometric shapes, one or more arbitrarily complex geometric shapes, and/or other geometric shapes.

In some implementations, a structure may include a hollow structure, a support structure, a moving structure, and/or other structures. A hollow structure may refer to a structure that includes one or more empty spaces within the structure. The empty space(s) may be used to hold, carry, transport, and/or otherwise interact with one or more things. For example, a hollow structure may include a vehicle, a container, a pipe, a pressure vessel, a tank, and/or other hollow structure. A support structure may refer to a structure that provides support for one or more things. For example, a support structure may include an installation, a platform, a frame, a crane, a beam, fixed equipment, and/or other support structure. A moving structure may refer to a structure that moves to perform its function. For example, a moving structure may include a turbine blade, offline rotating equipment, and/or other moving structure. Non-limiting examples of structures include one or more parts or entirety of offshore floating production installations (such as spars, semisubmersibles, tension leg platforms), oil rigs, ship/barge hulls, offshore mobile drilling units, aircrafts, space launch vehicles, wind turbine blades, pressure vessels, piping systems, ballast tanks, void tanks, and cargo tanks. Other types of structures are contemplated.

In some implementations, a structure may refer to a portion of a larger structure. For example, a structure may refer to a region of interest of a larger structure. For instance, rather than inspecting the coating of the entire structure, a particular portion of the coating of the structure may be inspected. As another example, a structure may refer to a component of a larger structure. The component/part of the component may be inspected.

Acoustic excitation measurement from a structure may be processed and analyzed using physics models to detect defects in the structure. The use of physics models to detect defects may require significant optimization step by the user (e.g., operator) to achieve interpretable results. Additionally, the user's experience may be crucial for proper analysis and interpretation of the results. The user may need to understand the underlying physics of how sound moves through materials in order to accurately interpret the results. Moreover, the physics models may not account for the entirety of the physical processes taking place and hence introduce errors into the analysis.

The present disclosure utilizes machine learning models as proxy of the physics models to detect defects in structures. Different machine learning models are trained to detect different types of defects. The training data for the machine learning models includes real waveforms/wavefields and/or simulated waveforms/wavefields measured from a structure over time durations and labels of defects in the structure. The training enable the machine learning models to gain a deep understanding of the complex relationships between waveforms/wavefields, material properties, and structural defects. Using rich and diverse training data enables the machine learning models to generalize well to real-world scenarios and provide accurate inspection results. The present disclosure provides a tool for fast and accurate detection/characterization of defects in the structure without the need for user experience and/or physics models to interpret the results of acoustic excitation analysis. The tool improves the overall inspection process by providing more accurate, efficient, and effective results by encompassing the full physical response of the structure and removing the reliance of subjective optimization and interpretation by the user. The tool utilizes machine learning models that are trained on multiple images simultaneously. Waveforms/wavefields measured from structures at different moments in time are captured as different images. Multiple images captured over a duration of time are paired with a single defect characterization for training. This approach enables the machine learning models to learn features from acoustic wave amplitude propagation over time. The trained machine learning models receive multiple images as input and interpret the features from acoustic wave amplitude propagation over time to provide prediction on structural defects/defect characteristics.

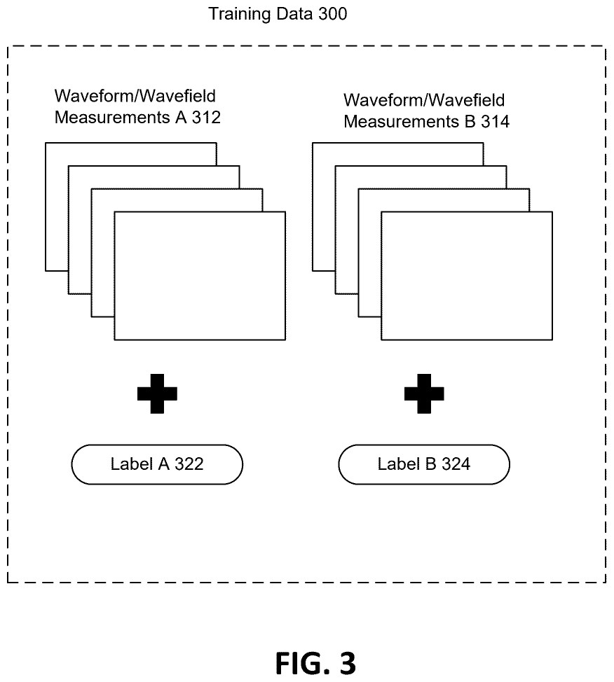

FIG. 3 illustrates example training data 300 for structural inspection. The training data 300 may include pairs of waveform measurements and labels. For example, the training data 300 may include waveform/wavefield measurements A 312 paired with a single label A 322 and waveform/wavefield measurements B 314 paired with a single label B 324. The waveform/wavefield measurements A 312 may include multiple measurements of waveforms/wavefields from a structure over a duration of time. The waveform/wavefield measurements A 312 may include multiple images depicting waveforms/wavefields measured from a structure over a duration of time. The label A 322 may include defect characterization of the structure from which the waveform/wavefield measurements A 312 were measured. The label A 322 may characterize one or more defects in the structure over the duration of time over which the waveform/wavefield measurements A 312 were measured. The label A 322 may identify one or more defects in the structure and/or one or more characteristics of defect(s) in the structure.

The waveform/wavefield measurements B 314 may include multiple measurements of waveforms/wavefields from a structure over a duration of time. The waveform/wavefield measurements B 314 may be measured from the same or different structure as the waveform/wavefield measurements A 312. The waveform/wavefield measurements B 314 may include multiple images depicting waveforms/wavefields measured from a structure over a duration of time. The label B 324 may include defect characterization of the structure from which the waveform/wavefield measurements B 314 were measured. The label B 324 may characterize one or more defects in the structure over the duration of time over which the waveform/wavefield measurements B 314 were measured. The label B 324 may identify one or more defects in the structure and/or one or more characteristics of defect(s) in the structure.

The training data 300 may be used to train a machine learning model simultaneously using multiple measurements taken at different moments in time. The training data 300 includes multiple measurements taken over a duration of time paired with a single defect characterization for training of machine learning models. For example, rather than pairing a single image of waveform/wavefield measurement with a single label of defect characterization for machine learning training, multiple images of waveform/wavefield measurements are paired with a single label of defect characterization for machine learning training.

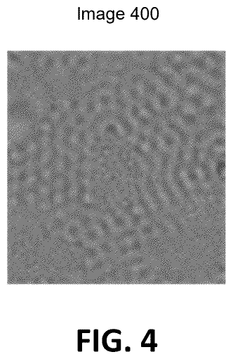

FIG. 4 illustrates an example acoustic excitation measurement from a structure. The acoustic excitation measurement from a structure may include waveforms/wavefields measured from a structure. For example, the waveforms/wavefields measured from a structure may be depicted within an image 400. Different defects in the structure may result in different waveforms/wavefields being measured from the structure. Different defects in the structure may result in different acoustic wave amplitude propagation over time. The acoustic wave amplitude propagation over time may be depicted within different images captured over a duration of time.

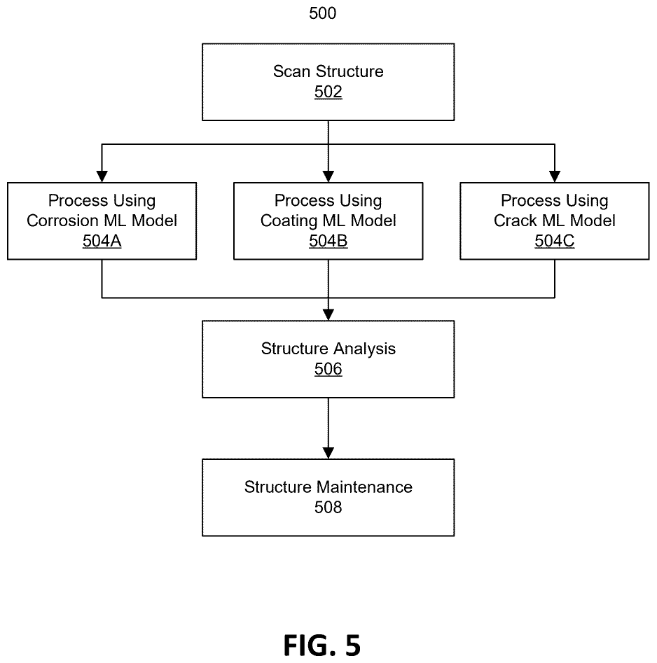

FIG. 5 illustrates an example process 500 for structural inspection. In the process 500, a structure may be scanned 502 to obtain acoustic excitation measurement from the structure, such as by using a laser-doppler vibrometer or other acoustic excitation measurement device(s). Acoustic excitation measurement may include images of waveforms/wavefields measured from the structure over a duration of time. The acoustic excitation measurement may be processed using different machine learning models. Different machine learning models may have been trained using different training data to detect different types of structural defects, such as corrosion, coating failure, and/or crack. For example, the acoustic excitation measurement from the structure may be processed using a corrosion machine learning model 504A to detect corrosions in the structure, a coating machine learning model 504B to detect coating failures in the structure, and a crack machine learning model 504C to detect cracks in the structure. Different machine learning models may output predictions on types of defect in the structure and/or characteristics of defects in the structure. For example, the corrosion machine learning model may output predictions on whether the structure includes corrosions and/or characteristics of corrosions in the structure (e.g., location, size, and/or shape of corrosions). The coating machine learning model may output predictions on whether the structure includes coating failures and/or characteristics of coating failures in the structure (e.g., location, size, and/or shape of coating failures). The crack machine learning model may output predictions on whether the structure includes cracks and/or characteristics of cracks in the structure (e.g., location, size, and/or shape of cracks). Structural analysis 506 may be performed based on the predictions output by the different machine learning models. Structural analysis 506 may be performed based on predictions on types of defect in the structure and/or characteristics of defects in the structure. Structural analysis 506 may include determination of the health of the structure (e.g., remaining life of the structure, probability of structural failure, extent of damage to the structure). Structural analysis 506 may include determination of what defects exist in the structure and/or characteristics of defects in the structure. Structure maintenance 508 may be performed based on the structural analysis 506. For example, the types and/or characteristics of defects detected in the structure may be used to determine whether the structure is sound. The types and/or characteristics of defects detected in the structure may be used to determine whether normal/planned operation with the structure may proceed or whether one or more maintenance operations (e.g., additional inspection, remediation) are required. Maintenance operations may be scheduled and/or performed based on the types and/or characteristics of defects detected in the structure.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate structural inspection. The machine-readable instructions 100 may include one or more computer program components. The machine-readable instructions 100 may include a measurement component 102, a characterization component 104, a train component 106, a storage component 108, an excitation component 110, a defect component 112, and/or other computer program components.

The measurement component 102 may be configured to obtain different sets of acoustic excitation measurement for different defects. Obtaining acoustic excitation measurement for a defect may include one or more of accessing, acquiring, analyzing, determining, examining, identifying, generating, loading, locating, making, measuring, opening, receiving, retrieving, reviewing, selecting, storing, taking, and/or otherwise obtaining the acoustic excitation measurement for a defect. Acoustic excitation measurement for a defect may be obtained using one or more acoustic measurement devices. Acoustic excitation measurement for a defect may be obtained from an acoustic measurement device and/or other location. For example, an acoustic measurement device may generate information that characterizes, defines, identifies, and/or reflects the acoustic excitation measurement, and the information may be obtained directly from the acoustic measurement device and/or indirectly from the acoustic measurement device (e.g., from electronic storage of the acoustic measurement device). The information may be obtained from other electronic storage devices.

A set of acoustic excitation measurement may include one or more acoustic excitation measurements. Different sets of acoustic excitation measurement may be obtained for different defects in one or more structures. Acoustic excitation measurement may include measurement of acoustic excitation in a structure. Acoustic excitation measurement may include measurement of acoustic excitation in one or more parts of a structure or the entirety of the structure. Acoustic excitation measurement may include measurement of acoustic response (e.g., displacement response, velocity response, acceleration response) in the structure. Measurement of acoustic excitation in a structure may include the acoustic response to the acoustic excitation in the structure. Acoustic excitation measurement may include waveforms/wavefields measured from a structure over a duration of time.

In some implementations, waveforms/wavefields may be measured from structure(s) over durations of time using multiple cycles of laser scanning. The waveforms/wavefields measured from the structure(s) over the durations of time may include time-series data of wave amplitudes and scanned locations on the structure(s). For example, the waveforms/wavefields measured from the structure(s) may be stored as (1) values of wave amplitude, (2) values of locations (e.g., x-coordinate, y-coordinate, z-coordinate), and (3) values of scanning time. In some implementations, the waveforms/wavefields measured at different moments in time may be captured as different images. For example, one or more cycles of laser scanning (e.g., 3+ cycles at 100 kHz) may be performed on a structure to measure the amplitudes of waveforms/wavefields at different locations in the structure. The measured amplitudes may be stored as an image of acoustic excitation measurement for a moment/duration in time. Multiple (e.g., hundreds, thousands) of images may be generated for acoustic excitation measurement taken at different times.

In some implementations, the waveforms/wavefields may be simulated using one or more physics models for the structure(s). For example, different physics models may exist for different types of defects. The physicals model for a particular type of defect (e.g., corrosion, coating failure, crack) may be used to simulate the presence of the particular type of defect in a structure and simulate acoustic excitation in the structure/acoustic excitation measurement from the structure.

Different sets of acoustic excitation measurement may be obtained from one or more structures. Acoustic excitation measurements may be obtained from one or more structures having a single type of defect and/or one or more structures having multiple types of defect.

Different sets of acoustic excitation measurement for different defects may include a first set of acoustic excitation measurement from the structure(s) for a first type of defect, a second set of acoustic excitation measurement from the structure(s) for a second type of defect different from the first type of defect, and/or other set(s) of acoustic excitation measurement from the structure(s) for other types of defect. In some implementations, the different sets of acoustic excitation measurement for different defects may further include a third set of acoustic excitation measurement from the structure(s) for a third type of defect. The third type of defect may be different from the first type of defect and the second type of defect. In some implementations, the first type of defect may include corrosion, the second type of defect may include coating failure, and the third type of defect may include crack. Corrosion may include material loss, such as wall thickness loss. Coating failure may include defect in the coating (e.g., blistering, bubbling, cratering, peeling, adhesion failure, delamination, separation from structure). Crack may include material cracking (e.g., in-plane cracking, out-of-plane cracking). Other types of defects are contemplated.

The characterization component 104 may be configured to obtain different sets of defect characterization for the structure(s). Obtaining a defect characterization for a structure may include one or more of accessing, acquiring, analyzing, determining, examining, identifying, generating, loading, locating, making, measuring, opening, receiving, retrieving, reviewing, selecting, storing, taking, and/or otherwise obtaining the defect characterization for the structure. Obtaining a defect characterization for a structure may include obtaining information that characterizes, defines, identifies, and/or reflects the defect characterization for the structure. The information may be obtained from one or more storage locations.

A set of defect characterization for a structure may include one or more defect characterization for the structure. A defect characterization may include characterization of one or more defects in a structure. A defect characterization may include description, identification, quantification, and/or other characterization of defect(s) in a structure. For example, a defect characterization may include information on the type of defect(s) in the structure and/or characteristics of defect(s) in the structure, such as the location, size, and/or shape of the defect(s) in the structure. Defect characterization may be performed by one or more persons (e.g., inspection of structure by subject matter experts), one or more tools (e.g., cameras, sensors, measurement devices), and/or through other methods.

Different sets of defect characterization for the structure(s) may correspond to different sets of acoustic excitation measurement from the structure(s). A single defect characterization may correspond to acoustic excitation measurement taken over a duration of time. For example, a single defect characterization (e.g., a type of defect, characteristic(s) of a defect) may correspond to multiple images (e.g., hundreds, thousands) depicting waveforms/wavefields measured from a structure over a duration of time.

Different sets of defect characterization may include a first set of defect characterization for the structure(s) corresponding to the first set of acoustic excitation measurement from the structure(s) for the first type of defect, a second set of defect characterization for the structure(s) corresponding to the second set of acoustic excitation measurement from the structure(s) for the second type of defect, and/or other sets of defect characterization for the structure(s) corresponding to other sets of acoustic excitation measurement from the structure(s) for other types of defect. In some implementations, different sets of defect characterization may further include a third set of defect characterization for the structure(s) corresponding to the third set of acoustic excitation measurement from the structure(s) for the third type of defect. For example, the first set of defect characterization may include corrosion characterization (e.g., identification of the defect in the structure as corrosion, corrosion location, size, and/or shape), the second set of defect characterization may include coating failure characterization (e.g., identification of the defect in the structure as coating failure, coating failure location, size, and/or shape), and the third set of defect characterization may include crack characterization (e.g., identification of the defect in the structure as crack, crack location, size, and/or shape). Other types of defect characterization are contemplated.

The train component 106 may be configured to train different machine learning models for structural inspection. A machine learning model may include multiple layers and components that work together to process the input data, extract relevant features, and make predictions. A machine learning model may include multiple components, such as convolutional neural networks (CNNs) for processing waveforms/wavefields, recurrent neural networks (RNNs) and/or Long Short-Term Memory (LSTM) networks for handling time series data (e.g., multiple images captured over a duration of time), and fully connected layers for output predictions. Training a machine learning model for structural inspection may include facilitating learning by the machine learning model by processing examples through the machine learning model.

Different machine learning models may be trained to determine different defect characteristics of structures. Different machine learning models may be trained to determine different defects in structures. Different machine learning models may be trained to determine characteristics of different defects in structures. The physics of acoustic excitation in structures (e.g., how wave travels through different defects) may be different for different types of defect. Given the differences in physics corresponding to different types of defects, exponentially greater resources may be required to train a machine learning model that can predict different kinds of defects. Greater efficiency may be gained by training individual smaller machine learning models for a single type of defect (e.g., a machine learning model for corrosion, a machine learning model for coating failure, a machine learning model for crack).

Different training data may be used to train different machine learning model for different defects. Training data to train a machine learning model for a particular type of defect may include acoustic excitation measurement from a structure having the particular type of defect and defect characterization (the type of defect, characteristics of the defect) of the structure. The pairings of corresponding acoustic excitation measurement and defect characterization may be provided to the machine learning model as examples of input and desired result, respectively. During training, the machine learning model may adjust its weighted association to produce the desired output.

For example, the different machine learning models may include a first machine learning model, a second machine learning model, and/or other machine learning models. The first machine learning model may be trained based on the first set of acoustic excitation measurement from the structure(s) for the first type of defect and the first set of defect characterization for the structure(s). The second machine learning model may be trained based on the second set of acoustic excitation measurement from the structure(s) for the second type of defect and the second set of defect characterization for the structure(s). In some implementations, the different machine learning models may further include a third machine learning model. The third machine learning model may be trained based on the third set of acoustic excitation measurement from the structure(s) for the third type of defect and the third set of defect characterization for the structure(s).

The acoustic excitation measurement may be used as the type of input to be received by the machine learning model and the defect characterization corresponding to/paired with the acoustic excitation measurement may be used as the type of output to be generated by the machine learning model. For example, a machine learning model may be trained by pairing multiple images captured over a duration of time with a single defect characterization. Multiple images depicting waveforms/wavefields measured from a structure over a duration of time may be paired with a single defect characterization (e.g., single label identifying the type of defect and/or describing the defect). Pairing of other information to train the machine learning models is contemplated. The acoustic excitation measurement/mages may be input into the machine learning model as a multi-dimensional array, such as a four-dimensional array include dimensions for (1) time/delta time, (2) x-position, (3) y-position, and (4) waveform/wavefield amplitude. The waveform/wavefield amplitude may be split into three different dimensions for three different image colors, resulting in a four by three matrix. The tuning window for the input may be adjusted to include multiples cycles of scanning (e.g., 3-4 cycles of scanning) to reduce noise.

Training of a machine learning models using waveforms/wavefields measured from structure(s) over duration(s) of time may enable the machine learning modes to learn and interpret features from acoustic wave amplitude propagation over time. For example, rather than training a machine learning model to determine defect characteristics from a single image of a structure (e.g., by pairing a single image of the structure with a single label for training), the machine learning model may be trained to learn and interpret features of acoustic wave amplitude propagation over time, as depicted across multiple images (e.g., by pairing multiple images of the structure with a single label for training). The machine learning model may be trained to process multiple images at once to determine defect characteristics. Rather than training a machine learning model to determine defect characteristics from static patterns of waveforms/wavefields in a single image, the machine learning model may be trained to learn and interpret features of dynamic patterns of waveforms/wavefields across multiple images. Different ways in which waves/amplitude of waves propagate over a structure may be used to determine the type of defect(s) in the structure and/or the characteristics (e.g., location, size, and/or shape) of defect(s) in the structure.

A trained machine learning model may provide estimation/prediction of defect characteristics in a structure based on acoustic excitation measurement from the structure. When waveforms/wavefields measured from the structure over a duration of time are input into a trained machine learning model for a particular type of defect, the trained machine learning model may output the estimated/predicted defect characteristics of the trained defect type in the structure. The trained machine learning model may output information from which the defect characteristics of the trained defect type in the structure may be estimated/predicted.

The storage component 108 may be configured to store the trained machine learning models for structural inspection. The trained machine learning models for structural inspection may be stored in one or more non-transient storage media and/or other storage media. For example, the storage component 108 may store the trained machine learning models/information defining the trained machine learning model in a storage location, such as the electronic storage 13, electronic storage of a device accessible via a network, and/or other locations. The trained machine learning models for structural inspection may be stored for use in determining (e.g., detecting, estimating, predicting) defect characteristics of a structure. The trained machine learning models for structural inspection may be stored for retrieval/running when determining defect characteristics of a structure.

The excitation component 110 may be configured to obtain acoustic excitation measurement from one or more structures. A structure may have one or more defects. Acoustic excitation measurement may be obtained for a structure to be inspected. Obtaining acoustic excitation measurement from a structure may include one or more of accessing, acquiring, analyzing, determining, examining, identifying, generating, loading, locating, making, measuring, opening, receiving, retrieving, reviewing, selecting, storing, taking, and/or otherwise obtaining the acoustic excitation measurement from a structure. Acoustic excitation measurement from a structure may be obtained using one or more acoustic measurement devices. Acoustic excitation measurement from a structure may be obtained from an acoustic measurement device and/or other location. For example, an acoustic measurement device may generate information that characterizes, defines, identifies, and/or reflects the acoustic excitation measurement from the structure, and the information may be obtained directly from the acoustic measurement device and/or indirectly from the acoustic measurement device (e.g., from electronic storage of the acoustic measurement device). The information may be obtained from other electronic storage devices.

Acoustic excitation measurement from a structure may include waveforms/wavefields measured from the structure over one or more durations of time. For example, the waveforms/wavefields may be measured from the structure over the duration(s) of time using multiple cycles of laser scanning. The waveforms/wavefields measured from the structure over the duration(s) of time may include time-series data of wave amplitudes and scanned locations on the structure. The waveforms/wavefields measured at different moments in time may be captured as different images, with the pixel values (e.g., color value, greyscale value) of the images reflecting the wave amplitudes at corresponding locations in the structure.

The defect component 112 may be configured to determine one or more defect characteristics in one or more structures. Defect characteristics in a structure may include the type of defect in the structure and/or characteristics of the defect in the structure (e.g., e.g., location, size, and/or shape). Determining defect characteristics in a structure may include ascertaining, approximating, calculating, establishing, estimating, finding, identifying, obtaining, performing, predicting, quantifying, and/or otherwise determining the defect characteristics in the structure. For example, the defect component 112 may determine the existence and/or absence of one or more defects in the structure, may identify the type of defect(s) in the structure, may identify the location of defect(s) in the structure, may determine the size of defect(s) in the structure, may determine the shape of the defect(s) in the structure, may quantify the defect(s) in the structure, and/or provide other determination of the defect(s) in the structure.

Defect characteristic(s) in a structure may be determined by using the trained machine learning models. Different trained machine learning models may be used to determine defect characteristics of different defect types. For example, the first machine learning model may be used to determine whether the defect(s) of a structure is a first type of defect (e.g., corrosion), the second machine learning model may be used to determine whether the defect(s) of a structure is a second type of defect (e.g., coating failure), and a third machine learning model may be used to determine whether the defect(s) of a structure is a third type of defect (e.g., crack).

The trained machine learning models may be used to further determine characteristics of different types of defect in a structure. The first machine learning model may be used to determine characteristics of the first type of defect (e.g., corrosion) in a structure, the second machine learning model may be used to determine characteristics of the second type of defect (e.g., coating failure) in a structure, and the third machine learning model may be used to determine characteristics of the third type of defect (e.g., crack) in a structure. The characteristics of different types of defect may include same type of characteristics (e.g., location, size, and/or shape) and/or characteristics specific to a type of defect (e.g., wall thickness for corrosion, type of coating failure, type of crack).

Acoustic excitation measurement from a structure may be input into different trained machine learning models (trained for different physics/mechanisms) and the different trained machine learning models may output predictions on the defect characteristics in the structure based on the acoustic excitation measurement from the structure and/or other information. For example, multiple images depicting waveforms/wavefields measured from a structure over a duration of time may be processed by different trained machine learning model. Different trained machine learning models may use the waveforms/wavefields measured from the structure over a duration of time to interpret features from acoustic wave amplitude propagation over time to make the predictions.

The predictions output by the different trained machine learning models may be used to determine the health/structural integrity of the structure. The predictions output by the different trained machine learning models may be used to perform integrity management for the structure (e.g., increase efficiency of/optimize integrity management). The predictions output by the different trained machine learning models may be used to make operational decisions and/or to perform operations for/using the structure. For example, one or more maintenance activities may be performed for a structure based on the defect characteristic(s) in the structure (output by the trained machine learning mode(s)) and/or other information. A maintenance activity may refer to an activity to repair a structure/defect in a structure. For example, a maintenance activity may be performed to repair corrosion, coating failure, and/or crack in the structure.

The defect characteristics of the structure as determined herein may be used to determine when, where, and/or how to perform maintenance work for the structure. The defect characteristics of the structure may be used to determine an overall health (e.g., overall health index) of the structure. The defect characteristics of the structure may be used to determine when, where, and/or how the structure needs to be repaired. For example, the defects in the structure may be classified based on the extent of the damage and/or the need for repair. The defect characteristics of the structure may be used to target different structures/parts of a structure for monitoring and/or repair. The timing of maintenance for the structure to repair the defect may be determined based on characteristics of the defects in the structure. For example, a pinhead-sized defect in the coating of the structure may be identified for monitoring, while a fingernail-sized defect in the coating of the structure may be identified for repair. As another example, a defect in a non-critical area of the structure may be identified for monitoring while a defect in a critical area of the structure may be identified for repair. Use of the trained machine learning models as described herein may enable quick and low-cost screening of a structure to identify parts of the structures that need to be monitored and/or repaired.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

As used herein, the phrase “configured to” is intended to be interpreted broadly, as “being capable of or suitable for performing” some function or feature, without requiring any adaptations to provide said function or feature.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

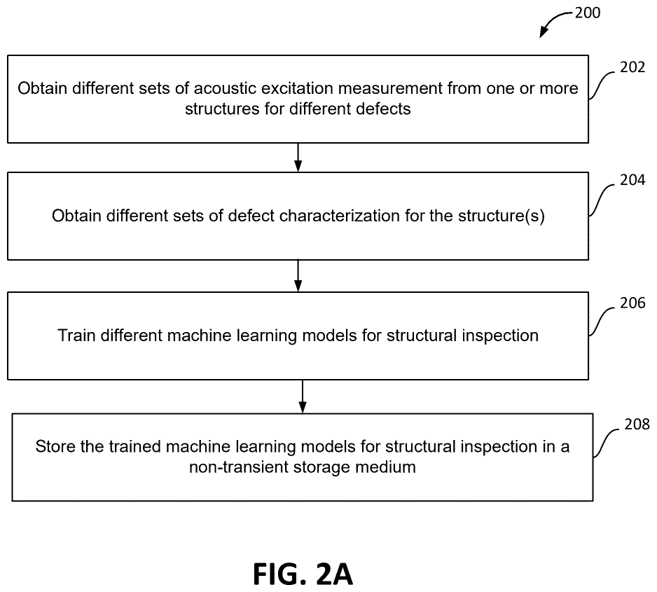

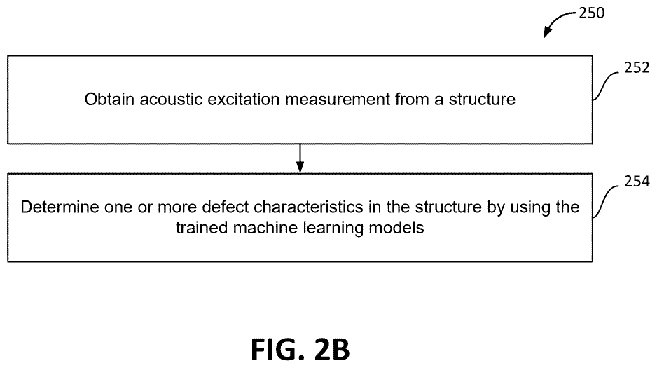

FIGS. 2A and 2B illustrate methods 200, 250 for structural inspection. The operations of methods 200, 250 presented below are intended to be illustrative. In some implementations, methods 200, 250 may be accomplished with one or more additional operations not described, and/or without one or more of the operations discussed. In some implementations, two or more of the operations may occur substantially simultaneously.

In some implementations, methods 200, 250 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2A and method 200, at operation 202, different sets of acoustic excitation measurement from one or more structures for different defects may be obtained. The different sets of acoustic excitation measurement from the structure(s) for different defects may include a first set of acoustic excitation measurement from the structure(s) for a first type of defect, a second set of acoustic excitation measurement from the structure(s) for a second type of defect different from the first type of defect, and/or other set(s) of acoustic excitation measurement from the structure(s) for other type(s) of defect. The different sets of acoustic excitation measurement from the structure(s) for different defects may include waveforms/wavefields measured from the structure(s) over durations of time. In some implementations, operation 202 may be performed by a processor component the same as or similar to the measurement component 102 (Shown in FIG. 1 and described herein).

At operation 204, different sets of defect characterization for the structure(s) may be obtained. The different sets of defect characterization for the structure(s) may correspond to the different sets of acoustic excitation measurement from the structure(s). The different sets of defect characterization for the structure(s) may include a first set of defect characterization for the structure(s) corresponding to the first set of acoustic excitation measurement from the structure(s) for the first type of defect, a second set of defect characterization for the structure(s) corresponding to the second set of acoustic excitation measurement from the structure(s) for the second type of defect, and/or other set(s) of defect characterization for the structure(s) corresponding to other set(s) of acoustic excitation measurement from the structure(s) for other type(s) of defect. In some implementations, operation 204 may be performed by a processor component the same as or similar to the characterization component 104 (Shown in FIG. 1 and described herein).

At operation 206, different machine learning models for structural inspection may be trained. The different machine learning models may include a first machine learning model, a second machine learning model, and/or other machine learning models. The first machine learning model may be trained based on the first set of acoustic excitation measurement from the structure(s) for the first type of defect, the first set of defect characterization for the structure(s), and/or other information. The second machine learning model may be trained based on the second set of acoustic excitation measurement from the structure(s) for the second type of defect, the second set of defect characterization for the structure(s), and/or other information. Training of the different machine learning models using the waveforms/wavefield measured from the structure(s) over the durations of time may enable the different machine learning models to learn and interpret features from acoustic wave amplitude propagation over time. In some implementations, operation 206 may be performed by a processor component the same as or similar to the train component 106 (Shown in FIG. 1 and described herein).

At operation 208, the trained machine learning models for structural inspection may be stored in a non-transient storage medium. In some implementations, operation 208 may be performed by a processor component the same as or similar to the storage component 108 (Shown in FIG. 1 and described herein).

Referring to FIG. 2B and method 250, at operation 252, acoustic excitation measurement from a structure may be obtained. The structure may have one or more defects. In some implementations, operation 252 may be performed by a processor component the same as or similar to the excitation component 110 (Shown in FIG. 1 and described herein).

At operation 254, one or more defect characteristics in the structure may be determined by using the trained machine learning models. The first machine learning model may be used to determine whether a defect of the structure is the first type of defect. The second machine learning model may be used to determine whether a defect of the structure is the second type of defect. In some implementations, operation 254 may be performed by a processor component the same as or similar to the defect component 112 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementations.

What is claimed is:

1. A system for structural inspection, the system comprising:
one or more physical processors configured by machine-readable instructions to:
obtain different sets of acoustic excitation measurement from one or more structures for different defects, the different sets of acoustic excitation measurement from the one or more structures for different defects including a first set of acoustic excitation measurement from the one or more structures for a first type of defect and a second set of acoustic excitation measurement from the one or more structures for a second type of defect different from the first type of defect, the different sets of acoustic excitation measurement from the one or more structures for different defects including waveforms/wavefields measured from the one or more structures over durations of time;
obtain different sets of defect characterization for the one or more structures, the different sets of defect characterization for the one or more structures corresponding to the different sets of acoustic excitation measurement from the one or more structures, the different sets of defect characterization for the one or more structures including a first set of defect characterization for the one or more structures corresponding to the first set of acoustic excitation measurement from the one or more structures for the first type of defect and a second set of defect characterization for the one or more structures corresponding to the second set of acoustic excitation measurement from the one or more structures for the second type of defect;
train different machine learning models for structural inspection, the different machine learning models including a first machine learning model trained based on the first set of acoustic excitation measurement from the one or more structures for the first type of defect and the first set of defect characterization for the one or more structures and a second machine learning model trained based on the second set of acoustic excitation measurement from the one or more structures for the second type of defect and the second set of defect characterization for the one or more structures, wherein training of the different machine learning models using the waveforms/wavefields measured from the one or more structures over the durations of time enables the different machine learning models to learn and interpret features from acoustic wave amplitude propagation over time; and
store the trained machine learning models for structural inspection in a non-transient storage medium.

2. The system of claim 1, wherein the one or more physical processors are further configured by the machine-readable instructions to:
obtain acoustic excitation measurement from a given structure, the given structure having a given defect; and
determine one or more defect characteristics in the given structure by using the trained machine learning models, wherein the first machine learning model is used to determine whether the given defect of the structure is the first type of defect and the second machine learning model is used to determine whether the given defect of the structure is the second type of defect.

3. The system of claim 2, wherein the first machine learning model is used to further determine characteristics of the first type of defect in the structure and the second machine learning model is used to further determine characteristics of the second type of defect in the structure.

4. The system of claim 2, wherein one or more maintenance activities for the given structure are performed based on the one or more defect characteristics in the given structure.

5. The system of claim 1, wherein:
the different sets of acoustic excitation measurement from the one or more structures for different defects further include a third set of acoustic excitation measurement from the one or more structures for a third type of defect different from the first type of defect and the second type of defect;
the different sets of defect characterization for the one or more structures further include a third set of defect characterization for the one or more structures corresponding to the third set of acoustic excitation measurement from the one or more structures for the third type of defect; and
the different machine learning models further include a third machine learning model trained based on the third set of acoustic excitation measurement from the one or more structures for the third type of defect and the third set of defect characterization for the one or more structures.

6. The system of claim 5, wherein:
the first type of defect includes corrosion and the first set of defect characterization includes corrosion characterization;
the second type of defect includes coating failure and the second set of defect characterization includes coating failure characterization; and
the third type of defect includes crack and the third set of defect characterization includes crack characterization.

7. The system of claim 1, wherein the waveforms/wavefields are measured from the one or more structures over the durations of time using multiple cycles of laser scanning.

8. The system of claim 7, wherein the waveforms/wavefields measured from the one or more structures over the durations of time include time-series data of wave amplitudes and scanned locations on the one or more structures.

9. The system of claim 8, wherein:
the waveforms/wavefields measured at different moments in time are captured as different images; and
a given machine learning model is trained by pairing multiple images captured over a given duration of time with a single defect characterization.

10. The system of claim 1, wherein the waveforms/wavefields are simulated using one or more physics models for the one or more structures.

11. A method for structural inspection, the method comprising:
obtaining different sets of acoustic excitation measurement from one or more structures for different defects, the different sets of acoustic excitation measurement from the one or more structures for different defects including a first set of acoustic excitation measurement from the one or more structures for a first type of defect and a second set of acoustic excitation measurement from the one or more structures for a second type of defect different from the first type of defect, the different sets of acoustic excitation measurement from the one or more structures for different defects including waveforms/wavefields measured from the one or more structures over durations of time;
obtaining different sets of defect characterization for the one or more structures, the different sets of defect characterization for the one or more structures corresponding to the different sets of acoustic excitation measurement from the one or more structures, the different sets of defect characterization for the one or more structures including a first set of defect characterization for the one or more structures corresponding to the first set of acoustic excitation measurement from the one or more structures for the first type of defect and a second set of defect characterization for the one or more structures corresponding to the second set of acoustic excitation measurement from the one or more structures for the second type of defect;
training different machine learning models for structural inspection, the different machine learning models including a first machine learning model trained based on the first set of acoustic excitation measurement from the one or more structures for the first type of defect and the first set of defect characterization for the one or more structures and a second machine learning model trained based on the second set of acoustic excitation measurement from the one or more structures for the second type of defect and the second set of defect characterization for the one or more structures, wherein training of the different machine learning models using the waveforms/wavefields measured from the one or more structures over the durations of time enables the different machine learning models to learn and interpret features from acoustic wave amplitude propagation over time; and
storing the trained machine learning models for structural inspection in a non-transient storage medium.

12. The method of claim 11, further comprising:
obtaining acoustic excitation measurement from a given structure, the given structure having a given defect; and
determining one or more defect characteristics in the given structure by using the trained machine learning models, wherein the first machine learning model is used to determine whether the given defect of the structure is the first type of defect and the second machine learning model is used to determine whether the given defect of the structure is the second type of defect.

13. The method of claim 12, wherein the first machine learning model is used to further determine characteristics of the first type of defect in the structure and the second machine learning model is used to further determine characteristics of the second type of defect in the structure.

14. The method of claim 12, wherein one or more maintenance activities for the given structure are performed based on the one or more defect characteristics in the given structure.

15. The method of claim 11, wherein:
the different sets of acoustic excitation measurement from the one or more structures for different defects further include a third set of acoustic excitation measurement from the one or more structures for a third type of defect different from the first type of defect and the second type of defect;
the different sets of defect characterization for the one or more structures further include a third set of defect characterization for the one or more structures corresponding to the third set of acoustic excitation measurement from the one or more structures for the third type of defect; and
the different machine learning models further include a third machine learning model trained based on the third set of acoustic excitation measurement from the one or more structures for the third type of defect and the third set of defect characterization for the one or more structures.

16. The method of claim 15, wherein:
the first type of defect includes corrosion and the first set of defect characterization includes corrosion characterization;
the second type of defect includes coating failure and the second set of defect characterization includes coating failure characterization; and
the third type of defect includes crack and the third set of defect characterization includes crack characterization.

17. The method of claim 11, wherein the waveforms/wavefields are measured from the one or more structures over the durations of time using multiple cycles of laser scanning.

18. The method of claim 17, wherein the waveforms/wavefields measured from the one or more structures over the durations of time include time-series data of wave amplitudes and scanned locations on the one or more structures.

19. The method of claim 18, wherein:
the waveforms/wavefields measured at different moments in time are captured as different images; and
a given machine learning model is trained by pairing multiple images captured over a given duration of time with a single defect characterization.

20. The method of claim 11, wherein the waveforms/wavefields are simulated using one or more physics models for the one or more structures.
